(19) United States
(12) Patent Application Publication
(10) Pub. No.: US 2005/0022125 A1
(43) Pub. Date: Jan. 27, 2005

(54) Method and tool set for creating content for digital video projects

(76) Inventor: Stacy Liane Powell, Duvall, WA (US)

Correspondence Address: Stacy Powell, 12609 269th Ave. NE, Duvall, WA, 98019, US

(21) Appl. No.: 10/897,742

(22) Filed: Jul. 24, 2004

Related U.S. Application Data
(60) Provisional application No. 60/490,073, filed on Jul. 25, 2003.

(51) Int. Cl. H04N 7/16; H04N 7/173

(52) U.S. Cl. 715/704; 725/135

(57) ABSTRACT

A method and tools for the creation of content for home video that is easy enough to be used by a person with no prior video creation experience and which allows the user to take advantage of continuing innovations in consumer video technology. This invention provides common movie-making elements and instruction in a combination and format that facilitates the creation of a plot-driven or content-driven movie. This method and tool set could be used as an entertaining and educational activity for children and adults.

### CROSS REFERENCE TO RELATED APPLICATION

Provisional Patent Application No. 60/490,073

Confirmation No. 2798

### STATEMENT REGARDING FEDERALLY SPONSORED R&D

Not Applicable

### REFERENCE TO SEQUENCE LISTING, A TABLE, OR A COMPUTER PROGRAM LISTING COMPACT DISK APPENDIX

Not Applicable

### BACKGROUND

1. Field of Invention

This invention relates to the evolution of digital video equipment for the consumer market and home video editing technology. The invention also relates to the field of educational activities.

2. Prior Art

The basic elements used to create professional movies are familiar to most people. Scripts, music, sound effects, costumes are available separately to the consumer. However, they require a sophisticated user and a great deal of time to be able to put all the elements together. This is something that is not feasible for most users and not practical for use with children.

The evolution of digital video equipment and home video editing technology is allowing more and more people to create their own movies. Digital camcorders and cameras along with desktop video editing software have made the movie-making process more accessible to the general public. This is proving to be especially popular among families looking to preserve a record of childhood activities. However, typical home movies lack structure and content and do not provide an educational experience for the children involved.

### OBJECTS AND ADVANTAGES

Accordingly, several objects and advantages to my invention are:

To provide a method and tools for the creation of content for home video that is easy enough to be used by a person with no prior video creation experience.

To provide common movie-making elements in a combination and format that facilitates the creation of a plot-driven or content-driven movie.

To provide this method and tool set in a manner that they could be used as an entertaining and educational activity for children and adults.

To provide a structure for content that takes advantage of continuing innovations in consumer video technology—both hardware and software.

To provide this method and tool set in a way that is not dependent on specific hardware or software tools.

To provide a structure and method that can accommodate a variety of content genres and topics so as to appeal to a wide audience.

### BRIEF SUMMARY OF INVENTION

This invention will be used to provide content and structure for the creation of plot or content-based home movies. The invention is comprised of a tool set which may include but is not limited to: a script and storyboard in a user-friendly format, scene directions, a soundtrack in digital format, costume and prop elements, title and scene graphics specific to the script. It also includes a method for facilitating the creation of a movie by combining the elements in the tool set with procedures that are outlined in a User's Manual or instruction book.

### BRIEF DESCRIPTION OF DRAWING

FIG. 1 illustrates a possible embodiment of the Script.

### DETAILED DESCRIPTION

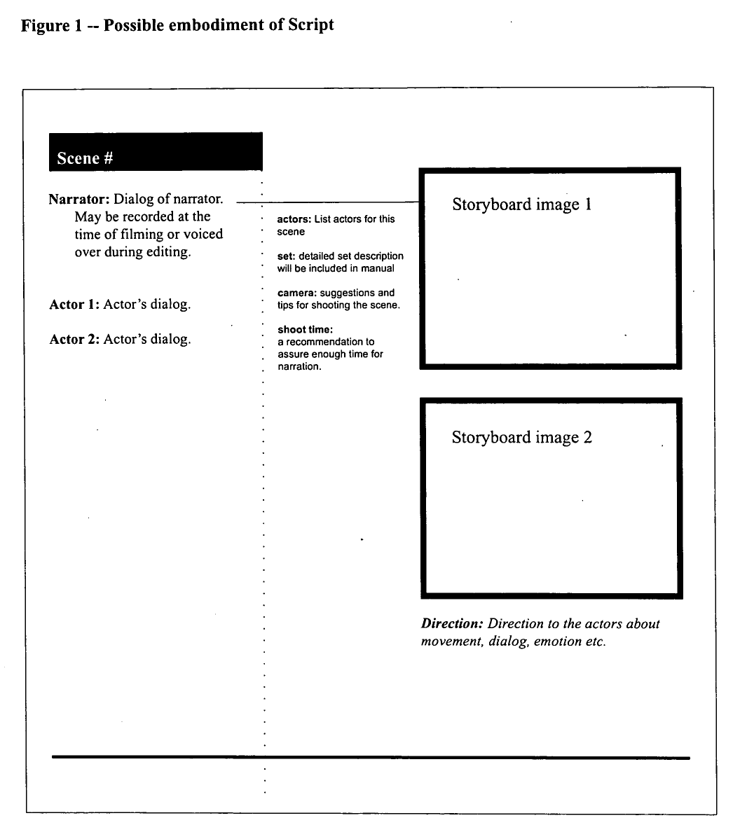

A typical embodiment of the invention would be an activity kit that includes but is not limited to the following:
1. A Script that is designed in a way to guide the user through the filming portion of a video project. This may be accomplished by combining a storyboard and scene directions with the text of the script in a way that leads the user through the filming of each scene. An example of this is shown in FIG. 1. In the cases where the actors are children, the text of the script could be mostly narration, making it unnecessary for the actors to memorize lines. This script may exist in either printed or digital format.
2. A digital Soundtrack that may include musical themes and sound effects provided in a format that can be imported into the movie.
3. Costumes or props and/or suggestions for creating costumes and props.
4. A step-by-step User's Manual that would guide the user through the process. This manual may be customized to the script with which it is included. This manual may be in printed or digital format. Said manual may include but is not limited to the following information.
   a. Project planning
   b. Set selection and preparation
   c. Costume preparation
   d. Ideas to improve filming technique
   e. Editing
   f. File compression
   g. Ways to involve the children in all parts of the process
5. Title and Scene Graphics, supplied in digital format may consist of still graphics, animations or film clips. These elements would be created using standard graphic or multimedia applications and included in the kit in formats that can be easily added to the movie.
   Operation of Invention

Although the elements of the Tool Set are familiar to most people, they will be designed in a way to optimize their usability for the novice user.

The Script (1) shown in FIG. 1 is an example to illustrate this point. The user would focus on one scene at a time. In addition to the story content, this script may include all instruction for a given scene on the same page. This may include but is not limited to: actors required, costume direction, set direction, camera angle suggestions, shooting time, and directions to the actors. Each scene may be laid out in the same self-contained manner. The Script could be used as a complete resource for the filming stage of the project.

The Soundtrack (2) may consist of a collection of digital themes and sound effects that the user can edit into their finished movie. They will be provided in a way that is easy to use for someone not skilled in video or sound editing. For instance., the soundtrack may contain simple repeatable themes that can be combined in a variety of ways. The user may select elements from the soundtrack and use them in the editing portion of the project.

Costume and prop elements (3) specific to the story, may be included. In addition, instructions to create costumes and props can be provided in the User's Manual (4).

Any additional information necessary for creating the finished movie will be included in the User's Manual (4). This may include project planning tips and instructions and for using standard digital editing applications for bringing the video, animation, graphic and sound elements together to create the final product. This also may include filming tips and techniques and suggestions on involving children in the editing phase. Information in this section will be general enough to accommodate a variety of computer platforms and software tools. The User's Manual will be used as a resource for project planning and editing phases of the project.

The Title and Scene Graphics (5), either as static elements, animations, or video footage, can be included to give the final product a finished look. These elements can be created using industry standard graphic and multimedia applications and provided to the user in standard formats.

Conclusion, Ramifications and Scope of Invention

Digital video technology has advanced in recent years to make it more accessible to the general consumer. There currently exists a great deal of hardware and software tools for the creation and editing of video images. This invention is intended to improve the consumer's finished product by providing content and structure for their movies.

The content can be provided in a wide variety of genres. This may include plot-based genres such as science fiction, fairy tales or detective stories. It also may include educational material to help teach subjects such as the alphabet or counting. As an educational activity it would foster creativity and self-expression as well as creative problem solving and project follow-through. Although this invention will be particularly useful in working with children, it is not limited in that sense.

This invention is not limited to human actors. For example, pets, dolls, or drawn or animated characters may play roles.

The tool set is a means of facilitating the creation of video content and should not be limited to those items listed in this description.

Variations on this invention are not limited to the typical embodiment described above. Another embodiment may be a structure for creating business-training videos wherein a company may use its own employees as actors to create customized videos on subjects such as safety or human resources issues.

In conclusion, this invention combines the common elements of filmmaking into an easy-to-follow method and tool set which allows consumers to improve their experience with evolving video technology.

1. A method of facilitating the creation of digital video content by providing a tool set which may consist of but is not limited to:
a. a script that includes detailed filming instructions
b. a User's Manual which includes detailed instruction on editing and other aspects of movie creation
c. digital content such as still graphics, animations, digital music and sound effects.
d. physical content such as costume or prop elements

2. A method of creating a digital movie for those unskilled in the art of movie-making.

3. A method of creating a digital movie that can be an educational experience for children and adults.
